(19) United States
(12) Patent Application Publication
(10) Pub. No.: US 2021/0365024 A1
(43) Pub. Date: Nov. 25, 2021

(54) METHOD AND DEVICE FOR POSITIONING UNMANNED VEHICLE

(71) Applicant: BEIJING BAIDU NETCOM SCIENCE TECHNOLOGY CO., LTD., Beijing (CN)

(72) Inventors: GAO YU, BEIJING (CN); JINGJING XUE, BEIJING (CN); SHENGLIN QIN, BEIJING (CN); LIE CHENG, BEIJING (CN)

(21) Appl. No.: 17/183,198

(22) Filed: Feb. 23, 2021

Related U.S. Application Data
(63) Continuation of application No. PCT/CN2019/103301, filed on Aug. 29, 2019.

(30) Foreign Application Priority Data
Jan. 16, 2019 (CN) 201910038128.X

(51) Int. Cl. G05D 1/00; G01C 21/36; G05D 1/02; B60W 60/00

(52) U.S. Cl. CPC G05D 1/0011; G01C 21/36; B60W 2556/10; G05D 1/0231; B60W 60/001; G05D 1/0274

(57) ABSTRACT

The embodiments of the present application provide a method and device for positioning unmanned vehicle. The method includes: sending a positioning request to a user terminal, when an abnormal positioning for an unmanned vehicle is detected; receiving auxiliary positioning information returned by the user terminal according to the positioning request, the positioning request including auxiliary positioning information, determining whether a position corresponding to the auxiliary positioning information exceeds a setting range corresponding to an actual position of the unmanned vehicle or not; acquiring environmental information of the unmanned vehicle, when the position corresponding to the auxiliary positioning information does not exceed the setting range corresponding to the actual position of the unmanned vehicle; and adjusting the position corresponding to the auxiliary positioning information according to the environmental information and a pre-stored electronic map.

### CROSS-REFERENCE TO RELATED APPLICATION

This application is a continuation of International Application PCT/CN2019/103301, filed on Aug. 29 2019, which claims the priority of Chinese Patent Application No. 201910038128.X, entitled “Method and Device for Positioning Unmanned Vehicle” filed to China National Intellectual Property Administration on Jan. 16, 2019, both of which are incorporated herein by reference in their entirety.

### TECHNICAL FIELD

The present application relates to the technical field of unmanned vehicles, and more particularly, to a method and a device for positioning unmanned vehicle.

### BACKGROUND

With the continuous advancement of artificial intelligence technology, considerable progress has been made in unmanned driving technology, and various unmanned vehicles are favored by more and more users.

At present, in the existing method for positioning unmanned vehicle, the positioning is performed mainly based on the on-board global positioning system (GPS), and then according to positioning information of the unmanned vehicle, the driving control of the unmanned vehicle is realized.

### SUMMARY

Embodiments of the present application provide a method and a device for positioning unmanned vehicle to solve the technical problem in the prior art that a cloud server needs to analyze driving data, which causes the cloud server is unable to modify the control of the unmanned vehicle timely.

In the first aspect, the embodiments of the present application provide a method for positioning unmanned vehicle, including:

sending a positioning request to a user terminal, when an abnormal positioning for an unmanned vehicle is detected;

receiving auxiliary positioning information returned by the user terminal according to the positioning request;

determining whether a position corresponding to the auxiliary positioning information exceeds a setting range corresponding to an actual position of the unmanned vehicle or not;

acquiring environmental information of the unmanned vehicle, when the position corresponding to the auxiliary positioning information does not exceed the setting range corresponding to the actual position of the unmanned vehicle; and

adjusting the position corresponding to the auxiliary positioning information according to environmental information and a pre-stored electronic map, so as to locate the unmanned vehicle.

Based on the technical content above, in the embodiments of the present application, it may position the unmanned vehicle when there is an abnormal positioning for the unmanned vehicle, so as to prevent a problem that the unmanned vehicle is unable to be positioned when passing a road with weak positioning signal, resulting in a positioning failure or a positioning error, and the unmanned vehicle may not be controlled accurately either.

In some implementations, the auxiliary positioning information is generated according to positioning coordinates input by a user to the user terminal according to a prompt of the positioning request.

In some implementations, before the determining whether a position corresponding to the auxiliary positioning information exceeds a setting range corresponding to an actual position of the unmanned vehicle or not, the method further comprises:

acquiring historical driving data of the unmanned vehicle in a pre-set time period before the abnormal positioning;

acquiring up-to-date positioning information and speed information of the unmanned vehicle from the historical driving data before the abnormal positioning of the unmanned vehicle; and

determining the setting range corresponding to the actual position of the unmanned vehicle, according to the up-to-date positioning information, the speed information, and a duration period of the abnormal positioning lasts.

Through the historical driving data of the unmanned vehicle in a pre-set time period before the abnormal positioning, the existing data may be used to determine the setting range corresponding to the actual position of the unmanned vehicle, thereby reducing the positioning cost.

In some implementations, the environmental information is an environmental image towards a pre-set orientation of the unmanned vehicle;

the adjusting the auxiliary positioning information according to environmental information and a pre-stored electronic map includes:

extracting multiple landmarks from the environmental image;

scanning the pre-stored electronic map according to the multiple landmarks, and determining latitudes and longitudes of the multiple landmarks in the pre-stored electronic map;

determining a latitude and a longitude of the unmanned vehicle according to a latitude and a longitude of each landmark; and

adjusting a position of the auxiliary positioning information according to the latitude and the longitude of the unmanned vehicle.

In some implementations, after the determining whether a position corresponding to the auxiliary positioning information exceeds a setting range corresponding to an actual position of the unmanned vehicle or not, the method further includes:

sending prompt information of the abnormal positioning to the user terminal, when the position corresponding to the auxiliary positioning information exceeds the setting range corresponding to the actual position of the unmanned vehicle.

The prompt information of abnormal positioning is sent via the user terminal, to prompt the user that the auxiliary positioning information input is inaccurate, and to re-input thereof.

In some implementations, detecting abnormal positioning of the unmanned vehicle includes:

detecting a signal strength of the positioning system of the unmanned vehicle; and

determining the abnormal positioning for the unmanned vehicle, when the signal strength is less than a setting signal strength

In some implementations, detecting abnormal positioning of the unmanned vehicle includes:

acquiring positioning information of a positioning system of the unmanned vehicle; and

determining the abnormal positioning for the unmanned vehicle, when the positioning information is incomplete.

In some implementations, after the adjusting the position corresponding to the auxiliary positioning information according to the environmental information and a pre-stored electronic map, so as to position the unmanned vehicle, the method further includes: sending a prompt message of successful positioning to the user terminal.

In some implementations, after the adjusting the position corresponding to the auxiliary positioning information according to the environmental information and a pre-stored electronic map, so as to position the unmanned vehicle, the method further includes: sending position information after repositioning and an abnormal time of positioning for the unmanned vehicle to a log server, so that the log server records a correspondence between the position information after repositioning and the abnormal time.

The time and the position of abnormal positioning are recorded by the log server, and the recorded information may be used subsequently by a maintenance personnel to make maintenance by strengthening a positioning system signal where the unmanned vehicle passes by.

In the second aspect, the embodiments of the present application provide a device for positioning unmanned vehicle, including:

a request sending module, configured to send a positioning request to a user terminal when an abnormal positioning for an unmanned vehicle is detected;

a positioning receiving module, configured to receive auxiliary positioning information returned by the user terminal according to the positioning request;

a position judgment module, configured to judge whether a position corresponding to the auxiliary positioning information exceeds a setting range corresponding to an actual position of the unmanned vehicle or not;

an environment acquisition module, configured to acquire environmental information of the unmanned vehicle when the position corresponding to the auxiliary positioning information does not exceed the setting range corresponding to the actual position of the unmanned vehicle; and

a positioning adjustment module, configured to adjust the position corresponding to the auxiliary positioning information according to the environmental information and a pre-stored electronic map, so as to position the unmanned vehicle.

In some implementations, the auxiliary positioning information is generated according to positioning coordinates input by a user to the user terminal according to a prompt of the positioning request.

In some implementations, the device further includes:

a first acquisition module, configured to acquire historical driving data of the unmanned vehicle in a pre-set time period before the abnormal positioning;

a second acquisition module, configured to acquire up-to-date positioning information and speed information of the unmanned vehicle from the historical driving data before the abnormal positioning of the unmanned vehicle; and

a setting range determination module, configured to determine the setting range corresponding to the actual position of the unmanned vehicle, according to the up-to-date positioning information, the speed information, and a duration period that the abnormal positioning lasts.

In some implementations, the environmental information is an environmental image towards a pre-set orientation of the unmanned vehicle;

the positioning adjustment module is configured to: extract multiple landmarks from the environmental image, scan the pre-stored electronic map according to the multiple landmarks, determine latitudes and longitudes of the multiple landmarks in the pre-stored electronic map, determine a latitude and a longitude of the unmanned vehicle according to a latitude and a longitude of each landmark; and adjust a position of the auxiliary positioning information according to the latitude and the longitude of the unmanned vehicle.

In some implementations, the device further includes: a first prompt information sending module, configured to send prompt information of the abnormal positioning to the user terminal, when the position corresponding to the auxiliary positioning information exceeds the setting range corresponding to the actual position of the unmanned vehicle.

In some implementations, the device further includes: a first abnormality detection module, configured to: detect a signal strength of the positioning system of the unmanned vehicle, and when the signal strength is less than a setting signal strength, determine the abnormal positioning for the unmanned vehicle.

In some implementations, the device further includes: a second abnormality detection module, configured to acquire the positioning information of a positioning system of the unmanned vehicle, and when the positioning information is incomplete, determine the abnormal positioning for the unmanned vehicle.

In some implementations, the device further includes: a second prompt information sending module, configured to send a prompt message of successful positioning to the user terminal after the positioning adjustment module adjusts the position corresponding to the auxiliary positioning information according to the environmental information and the pre-stored electronic map, so as to position the unmanned vehicle.

In some implementations, the device further includes: a log sending module, configured to send position information after repositioning and an abnormal time of positioning for the unmanned vehicle to a log server, so that the log server records a correspondence between the position information after repositioning and the abnormal time, after the positioning adjustment module adjusts the position corresponding to the auxiliary positioning information according to the environmental information and the pre-stored electronic map, so as to position the unmanned vehicle.

In the third aspect, the embodiments of the present application provide a device for positioning unmanned vehicle, including: at least one processor and a memory;

the memory stores computer-executable instructions; and

the at least one processor executes the computer-executable instructions stored in the memory, to cause the at least one processor executes the method for positioning unmanned vehicle of the first aspect.

In the fourth aspect, the embodiments of the present application provide a computer-readable memory medium, including: computer-executable instructions, when executed by a processor, cause the method for positioning unmanned vehicle of the first aspect to be performed.

The method and the device for positioning unmanned vehicle provided by the embodiments of the present application, where in the method, first the positioning request sent by the user terminal is received, when positioning abnormality of unmanned vehicle is detected, the positioning request contains auxiliary positioning information, and then it is determined whether the position corresponding to auxiliary positioning information exceeds the setting range of the actual position of the unmanned vehicle or not, when it does not exceed, the environmental information of the unmanned vehicle is acquired, and the corresponding position of the auxiliary positioning information is finally adjusted according to the environmental information and the electronic map, so as to position the unmanned vehicle. In the embodiments of the present application, it may position the unmanned vehicle when there is an abnormal positioning for the unmanned vehicle, so as to prevent a problem that the unmanned vehicle is unable to be positioned when passing a road with weak positioning signal, resulting in a positioning failure or a positioning error, and the unmanned vehicle may not be controlled accurately either.

### BRIEF DESCRIPTION OF DRAWINGS

In order to more clearly describe the technical solutions of embodiments of the present application or the prior art, the following will briefly introduce the drawings that need to be used in the description of the embodiments or the prior art. Obviously, the drawings in the following description are some embodiments of the present application. For those of ordinary skill in the art, other drawings may be acquired based on these drawings without creative effort.

FIG. 1 is a schematic diagram of an architecture of a positioning system of an unmanned vehicle according to embodiments of the present application;

FIG. 2 is a first schematic flowchart of a method for positioning unmanned vehicle according to embodiments of the present application;

FIG. 3 is a second schematic flowchart of a method for positioning unmanned vehicle according to embodiments of the present application;

FIG. 4 is a schematic diagram of a setting range corresponding to an actual position of the unmanned vehicle according to embodiments of the present application;

FIG. 5 is a third schematic flowchart of a method for positioning unmanned vehicle according to embodiments of the present application;

FIG. 6 is a first block diagram of a device for positioning unmanned vehicle according to embodiments of the present application;

FIG. 7 is a second block diagram of a device for positioning unmanned vehicle according to embodiments of the present application; and

FIG. 8 is a hardware schematic diagram of a device for positioning unmanned vehicle according to embodiments of the present application.

### DESCRIPTION OF EMBODIMENTS

In order to make the purpose, technical solutions and advantages of the embodiments of the present application clearer, the following will clearly and completely describe the technical solutions in the embodiments of the present application according to the drawings in the embodiments of the present application. Obviously, the described embodiments are part of the embodiments of the present application, not all of them. Based on the embodiments of the present application, all other embodiments acquired by those of ordinary skill in the art without creative effort shall fall within the protection scope of the present application.

Embodiments of the present application provide a method and a device for positioning unmanned vehicle to solve the technical problem in the prior art that a cloud server needs to analyze driving data, which causes the cloud server is unable to modify the control of the unmanned vehicle timely.

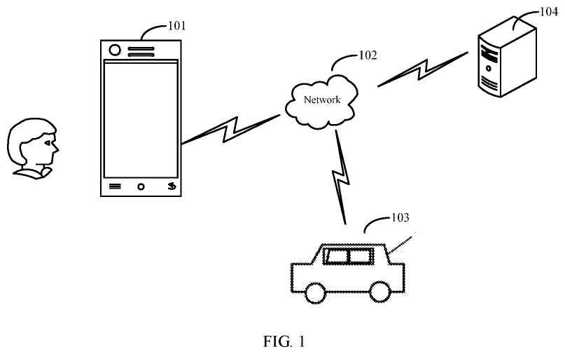

FIG. 1 is a schematic diagram of an architecture of a positioning system of an unmanned vehicle according to embodiments of the present application. As shown in FIG. 1, the system provided by the present embodiment includes a user terminal 101, a network 102, an unmanned vehicle 103, and a log server 104. Where, the user terminal 101 may be a mobile phone, a tablet, a vehicle-mounted terminal, and etc. The present embodiment does not particularly limit the implementation of the user terminal 101, as long as the user terminal 101 may position the unmanned vehicle with the user.

The network 102 may include various connection types, such as a wired communication link and a wireless communication link. Where, the wireless communication link may be a network such as WIFI, 4G, or 5G.

The unmanned vehicle 103 may interact with the user terminal 101 and the log server 104 via the network 102 to receive or send information and so on. The unmanned vehicle 103 may be equipped with a processor, a positioning system, an image acquisition device, and etc.

The log server 104 may be one server, a server cluster composed of multiple servers, or a cloud computing platform. The log server 104 may receive and save the failure log of the unmanned vehicle.

It should be understood that the quantity of the user terminal 101, the network 102, the unmanned vehicle 103, and the log server 104 in FIG. 1 is only illustrative, and the quantity of user terminals 101, the network 102, the unmanned vehicle 103, and the log server 104 may be set up to any other number according to a requirement.

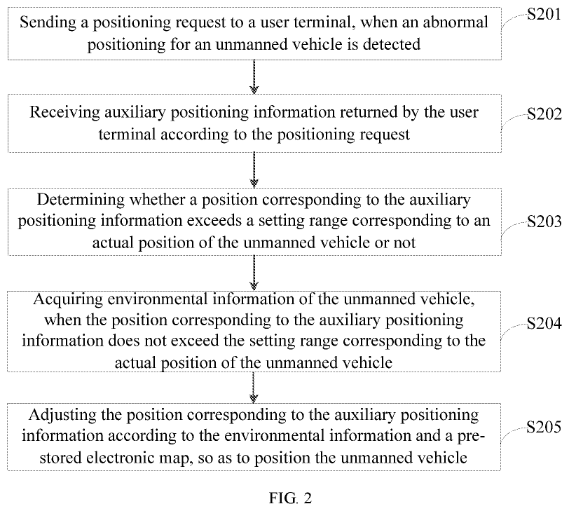

FIG. 2 is a first schematic flowchart of a method for positioning unmanned vehicle according to embodiments of the present application. The execution entity of the present embodiment may be the unmanned vehicle in the embodiment shown in FIG. 1, or the processor of unmanned vehicle in the embodiment shown in FIG. 1, which is not particularly limited in the present embodiment. As shown in FIG. 2, the method includes:

S201: sending a positioning request to a user terminal, when an abnormal positioning for an unmanned vehicle is detected.

In the present embodiment, the unmanned vehicle is generally positioned through a positioning system in the unmanned vehicle. The positioning system may be a GPS or a Beidou system. Unmanned vehicle positioning abnormalities include a positioning failure or a positioning error. Where, it may determine whether the positioning of unmanned vehicle is abnormal or not by detecting whether a signal strength of the positioning system can meet the requirements of positioning, and it may also determine whether the positioning of the unmanned vehicle is abnormal or not by detecting an integrity of the positioning information of the positioning system.

Specifically, the user may input position information to the user terminal, and the user terminal generates a positioning request according to the position information. For example, the user may input “intersection of Zhongshan Road and Xiumen Street” on the user terminal, and position coordinates of “intersection of Zhongshan Road and Xiumen Street” may be automatically positioned, and be added to the positioning request message.

S202: receiving auxiliary positioning information returned by the user terminal according to the positioning request.

In the embodiment of the present application, a user identification of a user may be carried in the positioning request. After the positioning request sent by the user terminal is received, an operation authority of the user may also be determined according to the positioning request. The details are as follows: detecting whether the user identification is saved in a correspondence between the user identification and the authority of the unmanned vehicle or not; if yes, acquiring the authority corresponding to the user identification according to the correspondence; when the authority is a manipulative user, the user terminal is allowed to perform positioning control of the unmanned vehicle, and to perform the subsequent steps; and when the authority is a non-manipulative user, a prompt message indicating that manipulation is prohibited is returned to the user terminal.

Where, the auxiliary positioning information is generated according to positioning coordinates input by a user to the user terminal according to a prompt of the positioning request.

S203: determining whether a position corresponding to the auxiliary positioning information exceeds a setting range corresponding to an actual position of the unmanned vehicle or not.

In the present embodiment, since the unmanned vehicle cannot perform normal positioning, the historical driving data of the unmanned vehicle may be analyzed to determine the setting range corresponding to the actual position of the unmanned vehicle. This setting range is an estimate value. The setting range corresponding to the actual position of the unmanned vehicle may be determined based on the position and the speed information of the unmanned vehicle at the moment before the abnormal positioning for the unmanned vehicle happens.

Specifically, the pre-set position information may be parsed, to acquire the position coordinates (for example, a latitude and a longitude) of the pre-set position information, to detect whether the position coordinates of the pre-set position information within the setting range corresponding to the actual position of the unmanned vehicle or not, and to determine whether the position corresponding to the auxiliary positioning information exceeds the setting range corresponding to the actual position of the unmanned vehicle or not.

S204: acquiring environmental information of the unmanned vehicle, when the position corresponding to the auxiliary positioning information does not exceed the setting range corresponding to the actual position of the unmanned vehicle.

In the present embodiment, the environmental information of the unmanned vehicle may be acquired through an image acquisition device installed on the unmanned vehicle. The environmental information may be information of an image or a video of the environment around the unmanned vehicle. For example, the surrounding environment of the unmanned vehicle includes “a landmark building” and “a road sign” near the unmanned vehicle.

S205: adjusting the position corresponding to the auxiliary positioning information according to the environmental information and a pre-stored electronic map.

In the present embodiment, landmarks such as “a landmark building” and “a road sign” may be extracted based on the environmental information, and the electronic map may be matched based on these landmarks to determine the position coordinates of these landmarks, and thereby the position of the unmanned vehicle may be determined based on the position coordinates of the landmarks, then a position in the pre-set position information may be adjusted.

From the above description, it can be seen that, first the positioning request sent by the user terminal is received, when positioning abnormality of unmanned vehicle is detected, the positioning request contains auxiliary positioning information, and then it is determined whether the position corresponding to auxiliary positioning information exceeds the setting range of the actual position of the unmanned vehicle or not, when it does not exceed, the environmental information of the unmanned vehicle is acquired, and the corresponding position of the auxiliary positioning information is finally adjusted according to the environmental information and the electronic map, so as to position the unmanned vehicle. In the embodiments of the present application, it may position the unmanned vehicle when there is an abnormal positioning for the unmanned vehicle, so as to prevent a problem that the unmanned vehicle is unable to be positioned when passing a road with weak positioning signal, resulting in a positioning failure or a positioning error, and the unmanned vehicle may not be controlled accurately either.

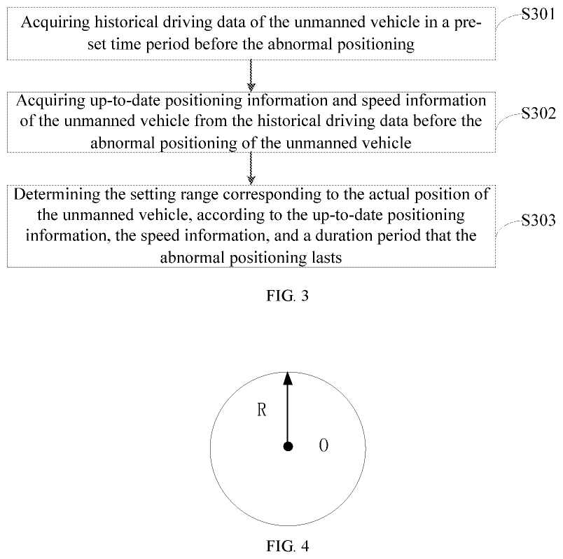

FIG. 3 is a second schematic flowchart of a method for positioning unmanned vehicle according to embodiments of the present application. Based on the embodiment of FIG. 2, the present embodiment illustrates a process of determining the setting range corresponding to the actual position of the unmanned vehicle before step S203 in detail. As shown in FIG. 3, the method includes:

S301: acquiring historical driving data of the unmanned vehicle in a pre-set time period before the abnormal positioning.

In the present embodiment, the pre-set time period before the abnormal positioning may be 5 minutes before the abnormal positioning. The historical driving data includes position information, speed information, a battery level, and road condition information of the unmanned vehicle.

S302: acquiring up-to-date positioning information and speed information of the unmanned vehicle from the historical driving data before the abnormal positioning of the unmanned vehicle.

In the present embodiment, the position information and speed information of the unmanned vehicle at a moment just before the abnormal positioning for the unmanned vehicle extracted from the historical driving data is the up-to-date position information and speed information before the abnormal positioning.

S303: determining the setting range corresponding to the actual position of the unmanned vehicle, according to the up-to-date positioning information, the speed information, and a duration period that the abnormal positioning lasts.

In the present embodiment, the duration period of the abnormal positioning lasts refers to the time from the detection of abnormal positioning for the unmanned vehicle until the time the unmanned vehicle receives the auxiliary positioning information returned by the user terminal according to the positioning request.

Referring to FIG. 4, FIG. 4 is a schematic diagram of a setting range corresponding to an actual position of an unmanned vehicle according to embodiments of the present application. A driving distance of the unmanned vehicle may be calculated through the duration period that the abnormal positioning lasts and the speed of the unmanned vehicle, and then the position of the unmanned vehicle at the previous moment is taken as a center O, making a circle therefrom with the driving distance of the unmanned vehicle during the duration period that the abnormal positioning lasts as a radius R, thereby acquiring the setting range corresponding to the actual position of the unmanned vehicle.

From the above description, it can be seen that the historical driving data of the unmanned vehicle in the pre-set time period before the abnormal positioning may be used to determine the setting range corresponding to the actual position of the unmanned vehicle, thereby reducing the positioning cost.

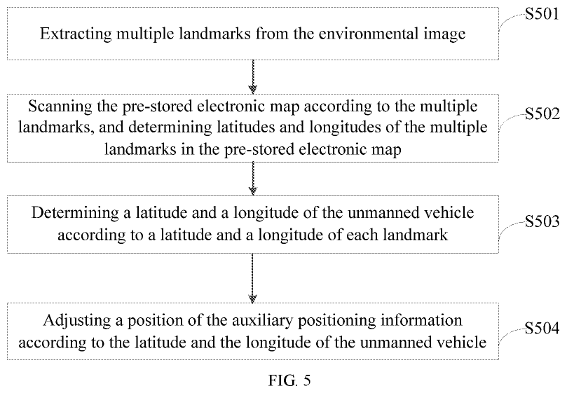

FIG. 5 is a third schematic flowchart of a method for positioning unmanned vehicle according to embodiments of the present application. Based on the embodiment of FIG. 2, the environmental information is an environmental image towards a pre-set orientation of the unmanned vehicle, the present embodiment describes in detail the process of adjusting the position corresponding to the auxiliary positioning information described in step S205 according to the environmental information and the pre-stored electronic map. As shown in FIG. 5, the method includes:

S501: extracting multiple landmarks from the environmental image.

In the present embodiment, multiple environmental images towards the pre-set orientation of the unmanned vehicle may be 360-degree panoramic images taken by the on-board camera device on the unmanned vehicle.

Specifically, the environment images may be input into a trained neural network model to acquire the multiple landmarks, where the neural network model is acquired by training pre-acquired labeled environment images.

S502: scanning the pre-stored electronic map according to the multiple landmarks, and determining latitudes and longitudes of the multiple landmarks in the pre-stored electronic map.

In the present embodiment, according to types and relative positions of the multiple landmarks, multiple landmarks with types and relative positions consistent with that of the multiple landmarks may be found on the pre-stored electronic map by scanning, and the latitudes and the longitudes of the multiple landmarks may be determined in the pre-stored electronic map.

S503: determining a latitude and a longitude of the unmanned vehicle according to a latitude and a longitude of each landmark.

In the present embodiment, the longitude and the latitude of the unmanned vehicle is determined by means of multilateration according to the latitude and the longitude of each landmark and the distance between each landmark and the unmanned vehicle.

S504: adjusting a position of the auxiliary positioning information according to the latitude and the longitude of the unmanned vehicle.

In the present embodiment, the latitude and the longitude of the position of the auxiliary positioning information is acquired. When the latitude and the longitude error between the unmanned vehicle and the position of the auxiliary positioning information does not exceed a given longitude and latitude threshold, the position of the auxiliary positioning information will be kept on being taken as the position of unmanned vehicle; when the latitude and longitude error of the unmanned vehicle and the position of the auxiliary positioning information exceeds the given longitude and latitude threshold, an arithmetic average of the longitude and the latitude of the unmanned vehicle and the position of the auxiliary positioning information will be taken as the position of unmanned vehicle.

In some embodiments, in step S203 of the embodiment in FIG. 2, after the determining whether a position corresponding to the auxiliary positioning information exceeds a setting range corresponding to an actual position of the unmanned vehicle or not, the method further comprises:

sending prompt information of the abnormal positioning to the user terminal, when the position corresponding to the auxiliary positioning information exceeds the setting range corresponding to the actual position of the unmanned vehicle.

From the above description, it can be seen that the user terminal sends the prompt information of abnormal positioning to prompt the user that the auxiliary positioning information input is inaccurate, and to re-input thereof.

In some embodiments, the process of detecting abnormal positioning for the unmanned vehicle before step S201 in the embodiment of FIG. 2 includes: detecting a signal strength of the positioning system of the unmanned vehicle; and determining the abnormal positioning for the unmanned vehicle, when the signal strength is less than a setting signal strength.

In the present embodiment, the positioning abnormality may be quickly determined by detecting a strength of the GPS positioning signal or the Beidou positioning signal.

In some embodiments, the process of detecting abnormal positioning for the unmanned vehicle before step S201 in the embodiment of FIG. 2 includes: acquiring positioning information of a positioning system of the unmanned vehicle; and determining the abnormal positioning for the unmanned vehicle, when the positioning information is incomplete.

In the present embodiment, the positioning information of the positioning system may include the latitude and the longitude of the unmanned vehicle and an orientation of the unmanned vehicle. When the positioning information only contains the latitude and the longitude or the orientation of the unmanned vehicle, that is, the positioning information is incomplete, and the positioning of the unmanned vehicle is determined as abnormal.

In some embodiments, after step S205 in the embodiment of FIG. 2, the method further comprises:

sending a prompt message of successful positioning to the user terminal, to prompt the user that the positioning for the unmanned vehicle is succeeded by the user terminal.

In some embodiments, after step S205 in the embodiment of FIG. 2, the method further includes:

sending position information after repositioning and an abnormal time of positioning for the unmanned vehicle to a log server, so that the log server records a correspondence between the position information after repositioning and the abnormal time.

From the above description, it can be seen that, the position and time of abnormal positioning are recorded by the log server, and the recorded information may be used subsequently by a maintenance personnel to make maintenance by strengthening the positioning system signal where the unmanned vehicle passes by.

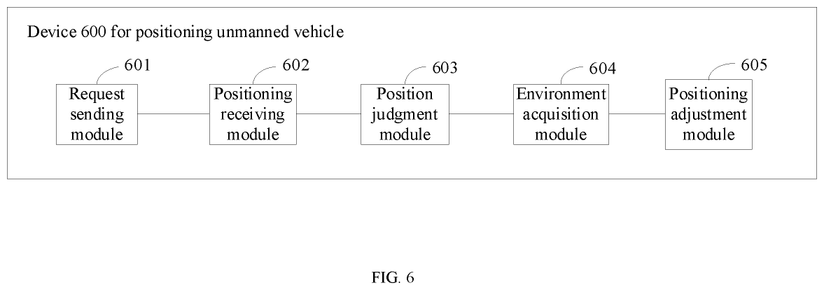

FIG. 6 is a first block diagram of a device for positioning unmanned vehicle according to embodiments of the present application. As shown in FIG. 6, the device 600 for positioning unmanned vehicle comprises: a request sending module 601, a positioning receiving module 602, a position judgment module 603, an environment acquisition module 604, and a positioning adjustment module 605.

The request sending module 601 is configured to send a positioning request to a user terminal when an abnormal positioning for an unmanned vehicle is detected;

The positioning receiving module 602 is configured to receive auxiliary positioning information returned by the user terminal according to the positioning request;

The position judgment module 603 is configured to judge whether a position corresponding to the auxiliary positioning information exceeds a setting range corresponding to an actual position of the unmanned vehicle or not;

The environment acquisition module 604 is configured to acquire environmental information of the unmanned vehicle when the position corresponding to the auxiliary positioning information does not exceed the setting range corresponding to the actual position of the unmanned vehicle;

The positioning adjustment module 605 is configured to adjust the position corresponding to the auxiliary positioning information according to the environmental information and a pre-stored electronic map, so as to position the unmanned vehicle.

The device provided in the present embodiment may be used to implement the technical solutions of the method embodiments discussed above, and its implementation principles and technical effects are similar therewith, and will not be repeated here in the present embodiment.

In some embodiments, the positioning receiving module is specifically configured to receive auxiliary positioning information returned by the user terminal, wherein, the auxiliary positioning information is generated according to positioning coordinates input by a user to the user terminal according to a prompt of the positioning request.

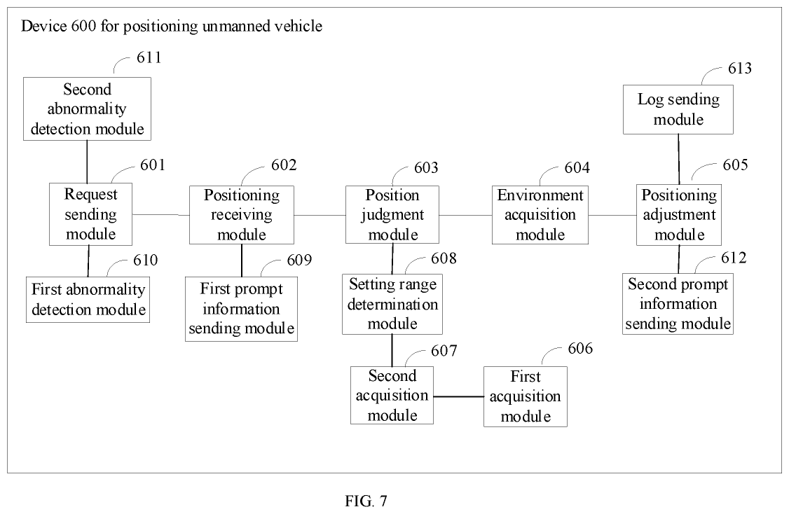

FIG. 7 is a second block diagram of a device for positioning unmanned vehicle according to embodiments of the present application. As shown in FIG. 7, on the basis of the embodiment in FIG. 6, the present embodiment further includes: a first acquisition module 606, a second acquisition module 607, and a setting range determination module 608.

The first acquisition module 606 is configured to acquire historical driving data of the unmanned vehicle in a pre-set time period before the abnormal positioning;

The second acquisition module 607 is configured to acquire up-to-date positioning information and speed information of the unmanned vehicle from the historical driving data before the abnormal positioning of the unmanned vehicle;

The setting range determination module 608 is configured to determine the setting range corresponding to the actual position of the unmanned vehicle, according to the up-to-date positioning information, the speed information, and a duration period that the abnormal positioning lasts.

In some embodiments, the environmental information is an environmental image towards a pre-set orientation of the unmanned vehicle; the positioning adjustment module 605 is specifically configured to extract multiple landmarks from the environmental image, scan the pre-stored electronic map according to the multiple landmarks, determine latitudes and longitudes of the multiple landmarks in the pre-stored electronic map, determine a latitude and a longitude of the unmanned vehicle according to a latitude and a longitude of each landmark; and adjust a position of the auxiliary positioning information according to the latitude and the longitude of the unmanned vehicle.

In some embodiments, referring to FIG. 7, the device further includes:

a first prompt information sending module 609, configured to send prompt information of abnormal positioning to the user terminal when the position corresponding to the auxiliary positioning information exceeds the setting range corresponding to the actual position of the unmanned vehicle.

In some embodiments, referring to FIG. 7, the device further includes:

a first abnormality detection module 610, configured to detect a signal strength of the positioning system of the unmanned vehicle, and when the signal strength is less than a setting signal strength, determine the abnormal positioning for the unmanned vehicle.

In some embodiments, referring to FIG. 7, the device further includes:

a second abnormality detection module 611, configured to acquire the positioning information of a positioning system of the unmanned vehicle, and when the positioning information is incomplete, determine the abnormal positioning for the unmanned vehicle.

In some embodiments, referring to FIG. 7, the device further includes:

a second prompt information sending module 612, configured to send a prompt message of successful positioning to the user terminal after the positioning adjustment module adjusts the position corresponding to the auxiliary positioning information according to the environmental information and the pre-stored electronic map, so as to position the unmanned vehicle.

In some embodiments, referring to FIG. 7, the device further includes:

a log sending module 613, configured to send position information after repositioning and an abnormal time of positioning for the unmanned vehicle to a log server, so that the log server records a correspondence between the position information after repositioning and the abnormal time, after the positioning adjustment module adjusts the position corresponding to the auxiliary positioning information according to the environmental information and the pre-stored electronic map, so as to position the unmanned vehicle.

The device provided in the present embodiment may be used to implement the technical solutions of the method embodiments discussed above, and its implementation principles and technical effects are similar therewith, and will not be repeated here in the present embodiment.

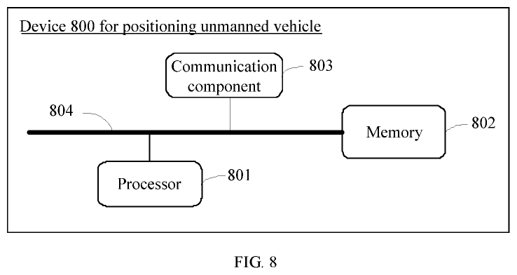

FIG. 8 is a hardware schematic diagram of a device for positioning unmanned vehicle according to embodiments of the present application. As shown in FIG. 8, the device 800 for positioning unmanned vehicle provided in the present embodiment includes: at least one processor 801 and a memory 802. The device 800 also includes a communication component 803. Wherein, the processor 801, the memory 802, and the communication component 803 are connected through a bus 804.

In a specific implementation process, the at least one processor 801 executes computer-executable instructions stored in the memory 802, so that the at least one processor 801 executes the method for positioning the unmanned vehicle based on the neural network in any of the method embodiments discussed above. The communication component 803 is configured to communicate with the terminal device and/or the server.

The specific implementation process of the processor 801 may be referred to the method embodiment discussed above, and its implementation principles and technical effects are similar therewith, which will not be repeated here in the present embodiment.

In the embodiment shown in above FIG. 8, it should be understood that the processor may be a central processing unit (CPU), or other general-purpose processors, digital signal processors (DSP), application specific integrated circuit (ASIC), and etc. The general-purpose processor may be a microprocessor or any conventional processor, and etc. The steps of the method disclosed in the present application may be directly embodied as executed by hardware processor, or executed by a combination of hardware and software modules in the processor.

The memory may include high-speed random access memory (RAM), and may also include non-volatile memory (NVM), such as at least one disk memory.

The bus may be an industry standard architecture (ISA) bus, a peripheral component interconnection (PCI) bus, or an extended industry standard architecture (EISA) bus. The bus may be divided into an address bus, a data bus, a control bus, and etc. For ease of representation, the buses in the drawings of the present application are not limited to only one bus or one type of bus.

In the several embodiments provided in the present application, it should be understood that the disclosed device and method may be implemented in other ways. For example, the device embodiments described above are only illustrative. For example, the division of the modules is only based on logical function, and there may be other divisions in actual implementation. For example, multiple modules may be combined or integrated to another system, or some landmarks may be ignored, or not implemented. In addition, the displayed or discussed mutual coupling or direct coupling or communication connection may be indirect coupling or communication connection through some interfaces, devices or modules, and may be in electrical, mechanical or other forms.

The modules described as separate components may or may not be physically separated, and the components displayed as modules may or may not be physical units, that is, they may be located in one place, or they may be distributed on multiple network units. Some or all of the modules may be selected according to actual needs to achieve the objectives of the solutions of the embodiments.

Moreover, the functional modules in the various embodiments of the present application may be integrated into one processing unit, or each module may exist alone physically, or two or more modules may be integrated into one unit. The units integrated by the modules discussed above may be realized in the form of hardware, or in the form of hardware plus software functional units.

The integrated modules discussed above implemented in the form of software function module may be stored in a computer readable memory medium. The software function module discussed above is stored in a memory medium, and includes several instructions to make a computer device (may be personal computer, server, or network device, and etc.) or a processor to execute part of the steps of the method discussed in various embodiments of the present application.

It should be understood that the processor discussed above may be central processing unit (CPU), or other general-purpose processors, digital signal processors (DSP), or application-specific integrated circuits (ASIC), etc. The general-purpose processor may be microprocessor or any conventional processor, etc. The steps of the method disclosed in the application may be directly embodied as the execution of the hardware processor, or executed by a combination of hardware and software modules in the processor.

The memory may include high-speed RAM memory, and may also include non-volatile memory NVM, such as at least one disk memory, and may also be universal serial bus (USB) flash drive, mobile hard disk drive, read-only memory, magnetic disk, or optical disk.

The bus may be industry standard architecture (ISA) bus, peripheral component interconnection (PCI) bus, or extended industry standard architecture (EISA) bus. The bus may be divided into address bus, data bus, control bus, etc. For ease of representation, the buses in the drawings of the present application are not limited to only one bus or one type of bus.

The memory medium discussed above may be realized by any type of volatile or non-volatile memory device or their combination, such as static RAM (SRAM), electrically erasable programmable read-only memory (EEPROM), erasable programmable read only memory (EPROM), programmable read only memory (PROM), read only memory (ROM), magnetic memory, flash memory, magnetic disk or optical disk. The memory medium may be any available medium that can be accessed by general-purpose or special-purpose computer.

An exemplary memory medium is coupled to the processor, so that the processor may read information from the memory medium and may write information to the memory medium. Of course, the memory medium may also be an integral part of the processor. The processor and the memory medium may be positioned in application specific integrated circuits (ASIC). Of course, the processor and the memory medium may also exist as discrete components in the electronic device or the main control device.

Those of ordinary skill in the art may understand that all or part of the steps of the method embodiments discussed above may be implemented by hardware relate to program instructing. The program discussed above may be stored in a computer readable memory medium. When the program is executed, the steps included in the method embodiments discussed above are executed; and the memory medium discussed above includes: ROM, RAM, magnetic disk, or optical disk and other media that may store program codes.

The method and the device for positioning unmanned vehicle provided by the embodiments of the present application, where in the method, first the positioning request sent by the user terminal is received, when positioning abnormality of unmanned vehicle is detected, the positioning request contains auxiliary positioning information, and then it is determined whether the position corresponding to auxiliary positioning information exceeds the setting range of the actual position of the unmanned vehicle or not, when it does not exceed, the environmental information of the unmanned vehicle is acquired, and the corresponding position of the auxiliary positioning information is finally adjusted according to the environmental information and the electronic map, so as to position the unmanned vehicle. In the embodiments of the present application, it may position the unmanned vehicle when there is an abnormal positioning for the unmanned vehicle, so as to prevent a problem that the unmanned vehicle is unable to be positioned when passing a road with weak positioning signal, resulting in a positioning failure or a positioning error, and the unmanned vehicle may not be controlled accurately either.

The description above is only specific implementations of the present application, but the protection scope of the present application is not limited to this. Changes or substitutions may be easily thought by any one skilled in the art fall within the technical scope disclosed in the present application. Therefore, the protection scope of the present application should be subject to the protection scope of the claims.

What is claimed is:

1. A method for positioning unmanned vehicle, comprising:
sending a positioning request to a user terminal, in response to a case that an abnormal positioning for an unmanned vehicle is detected;
receiving auxiliary positioning information returned by the user terminal according to the positioning request;
determining whether a position corresponding to the auxiliary positioning information exceeds a setting range corresponding to an actual position of the unmanned vehicle or not;
acquiring environmental information of the unmanned vehicle, in response to a case that the position corresponding to the auxiliary positioning information does not exceed the setting range corresponding to the actual position of the unmanned vehicle; and
adjusting the position corresponding to the auxiliary positioning information according to the environmental information and a pre-stored electronic map, so as to position the unmanned vehicle.

2. The method for positioning unmanned vehicle of claim 1, wherein the auxiliary positioning information is generated according to positioning coordinates input by a user to the user terminal according to a prompt of the positioning request.

3. The method for positioning unmanned vehicle of claim 1, wherein before the determining whether a position corresponding to the auxiliary positioning information exceeds a setting range corresponding to an actual position of the unmanned vehicle or not, the method further comprises:
acquiring historical driving data of the unmanned vehicle in a pre-set time period before the abnormal positioning;
acquiring up-to-date positioning information and speed information of the unmanned vehicle from the historical driving data before the abnormal positioning of the unmanned vehicle; and
determining the setting range corresponding to the actual position of the unmanned vehicle, according to the up-to-date positioning information, the speed information, and a duration period that the abnormal positioning lasts.

4. The method for positioning unmanned vehicle of claim 1, wherein the environmental information is an environmental image towards a pre-set orientation of the unmanned vehicle;
the adjusting the auxiliary positioning information according to environmental information and a pre-stored electronic map comprises:
extracting multiple landmarks from the environmental image;
scanning the pre-stored electronic map according to the multiple landmarks, and determining latitudes and longitudes of the multiple landmarks in the pre-stored electronic map;
determining a latitude and a longitude of the unmanned vehicle according to a latitude and a longitude of each landmark; and
adjusting a position of the auxiliary positioning information according to the latitude and the longitude of the unmanned vehicle.

5. The method for positioning unmanned vehicle of claim 1, wherein after the determining whether a position corresponding to the auxiliary positioning information exceeds a setting range corresponding to an actual position of the unmanned vehicle or not, the method further comprises:
sending prompt information of the abnormal positioning to the user terminal, in response to a case that the position corresponding to the auxiliary positioning information exceeds the setting range corresponding to the actual position of the unmanned vehicle.

6. The unmanned positioning method of claim 1, wherein detecting abnormal positioning of the unmanned vehicle comprises:
detecting a signal strength of the positioning system of the unmanned vehicle;
in response to a case that the signal strength is less than a setting signal strength, determining the abnormal positioning for the unmanned vehicle.

7. The unmanned positioning method of claim 1, wherein detecting abnormal positioning of the unmanned vehicle comprises:
acquiring positioning information of a positioning system of the unmanned vehicle; and
determining the abnormal positioning for the unmanned vehicle, in response to a case that the positioning information is incomplete.

8. The method for positioning unmanned vehicle of claim 1, wherein after adjusting the position corresponding to the auxiliary positioning information according to the environmental information and a pre-stored electronic map, so as to position the unmanned vehicle, the method further comprises:
sending a prompt message of successful positioning to the user terminal.

9. The method for positioning unmanned vehicle of claim 1, wherein after the adjusting the position corresponding to the auxiliary positioning information according to the environmental information and a pre-stored electronic map, so as to position the unmanned vehicle, the method further comprises:
sending position information after repositioning and an abnormal time of positioning for the unmanned vehicle to a log server, so that the log server records a correspondence between the position information after repositioning and the abnormal time.

10. A device for positioning unmanned vehicle, comprising at least one processor and a memory; wherein
the memory stores computer executable instructions; and
the at least one processor executes the computer executable instructions stored in the memory, to cause the at least one processor to:
send a positioning request to a user terminal in response to a case that an abnormal positioning for an unmanned vehicle is detected;
receive auxiliary positioning information returned by the user terminal according to the positioning request;
judge whether a position corresponding to the auxiliary positioning information exceeds a setting range corresponding to an actual position of the unmanned vehicle or not;
acquire environmental information of the unmanned vehicle in response to a case that the position corresponding to the auxiliary positioning information does not exceed the setting range corresponding to the actual position of the unmanned vehicle; and
adjust the position corresponding to the auxiliary positioning information according to the environmental information and a pre-stored electronic map, so as to position the unmanned vehicle.

11. The device for positioning unmanned vehicle of claim 10, wherein the auxiliary positioning information is generated according to positioning coordinates input by a user to the user terminal according to a prompt of the positioning request.

12. The device for positioning unmanned vehicle of claim 10, wherein the at least one processor executes the computer executable instructions stored in the memory, to cause the at least one processor to:
acquire historical driving data of the unmanned vehicle in a pre-set time period before the abnormal positioning;
acquire up-to-date positioning information and speed information of the unmanned vehicle from the historical driving data before the abnormal positioning of the unmanned vehicle; and
determine the setting range corresponding to the actual position of the unmanned vehicle, according to the up-to-date positioning information, the speed information, and a duration period that the abnormal positioning lasts.

13. The device for positioning unmanned vehicle of claim 10, wherein the environmental information is an environmental image towards a pre-set orientation of the unmanned vehicle; the at least one processor executes the computer executable instructions stored in the memory, to cause the at least one processor to:
extract multiple landmarks from the environmental image, scan the pre-stored electronic map according to the multiple landmarks, determine latitudes and longitudes of the multiple landmarks in the pre-stored electronic map, determine a latitude and a longitude of the unmanned vehicle according to a latitude and a longitude of each landmark; and adjust a position of the auxiliary positioning information according to the latitude and the longitude of the unmanned vehicle.

14. The device for positioning unmanned vehicle of claim 10, wherein the at least one processor executes the computer executable instructions stored in the memory, to cause the at least one processor to:
send prompt information of the abnormal positioning to the user terminal, in response to a case that the position corresponding to the auxiliary positioning information exceeds the setting range corresponding to the actual position of the unmanned vehicle.

15. The device for positioning unmanned vehicle of claim 10, wherein the at least one processor executes the computer executable instructions stored in the memory, to cause the at least one processor to:
detect a signal strength of the positioning system of the unmanned vehicle, and in response to a case that the signal strength is less than a setting signal strength, determine the abnormal positioning for the unmanned vehicle.

16. The device for positioning unmanned vehicle of claim 10, wherein the at least one processor executes the computer executable instructions stored in the memory, to cause the at least one processor to:
acquire the positioning information of a positioning system of the unmanned vehicle, and in response to a case that the positioning information is incomplete, determine the abnormal positioning for the unmanned vehicle.

17. The device for positioning unmanned vehicle of claim 10, wherein the at least one processor executes the computer executable instructions stored in the memory, to cause the at least one processor to:
send a prompt message of successful positioning to the user terminal after the at least one processor adjusts the position corresponding to the auxiliary positioning information according to the environmental information and the pre-stored electronic map, so as to position the unmanned vehicle.

18. The device for positioning unmanned vehicle of claim 10, wherein the at least one processor executes the computer executable instructions stored in the memory, to cause the at least one processor to:
send position information after repositioning and an abnormal time of positioning for the unmanned vehicle to a log server, so that the log server records a correspondence between the position information after repositioning and the abnormal time, after the at least one processor adjusts the position corresponding to the auxiliary positioning information according to the environmental information and the pre-stored electronic map, so as to position the unmanned vehicle.

19. A computer-readable memory medium, comprising: computer-executable instructions, when executed by a processor, cause the method for positioning unmanned vehicle of claim 1 to be performed.
